(19) United States
(12) Patent Application Publication
(10) Pub. No.: US 2022/0371402 A1
(43) Pub. Date: Nov. 24, 2022

(54) THERMAL MANAGEMENT SYSTEM FOR BATTERY ELECTRIC VEHICLE

(71) Applicants: TOYOTA JIDOSHA KABUSHIKI KAISHA, Toyota-shi (JP); SUBARU CORPORATION, Tokyo (JP)

(72) Inventors: Yoshio Hasegawa, Toyota-shi Aichi-ken (JP); Satoshi Furukawa, Kariya-shi (JP); Mitsuyo Omura, Kariya-shi Aichi-ken (JP)

(73) Assignees: TOYOTA JIDOSHA KABUSHIKI KAISHA, Toyota-shi (JP); SUBARU CORPORATION, Tokyo (JP)

(21) Appl. No.: 17/714,532

(22) Filed: Apr. 6, 2022

(30) Foreign Application Priority Data
May 24, 2021 (JP) 2021-087096

(51) Int. Cl. B60H 1/00

(52) U.S. Cl. CPC B60H 1/00885; B60H 1/00278

(57) ABSTRACT

In a thermal management system for a battery electric vehicle, a controller is configured to, in a heating mode, control a switching valve to select a first valve position when a power supply temperature is higher than a predetermined power supply temperature threshold, and control the switching valve to select a second valve position when the power supply temperature is equal to or lower than the power supply temperature threshold. The controller is configured to switch the switching valve from the first valve position to the second valve position regardless of the power supply temperature, when a temperature of a heat medium that has passed through a power supply cooler is lower than an outside air temperature by a predetermined margin temperature difference or more while the switching valve is in the first valve position.

### CROSS-REFERENCE TO RELATED APPLICATION

This application claims priority to Japanese Patent Application No. 2021-087096 filed on May 24, 2021, incorporated herein by reference in its entirety.

### BACKGROUND

### 1. Technical Field

The technique disclosed herein relates to a thermal management system for a battery electric vehicle.

### 2. Description of Related Art

There is a thermal management system that uses the heat of the outside air to heat a vehicle cabin. An example of such a thermal management system is disclosed in Japanese Unexamined Patent Application Publication No. 2012-158197 (JP 2012-158197 A).

### SUMMARY

A battery electric vehicle is provided with a power supply that supplies electric power to a motor for traveling. The heat of the power supply can also be used to heat the vehicle cabin. The present disclosure provides a thermal management system that can efficiently use the heat of a power supply and the heat of the outside air to heat a vehicle cabin.

A thermal management system according to one aspect of the disclosure includes a power supply that supplies electric power to a motor for traveling; a power supply cooler that cools the power supply with a heat medium; a heater that heats a vehicle cabin with heat of the heat medium; an outside air heat exchanger that exchanges heat between the heat medium and outside air; a circulation path that connects the power supply cooler, the heater, and the outside air heat exchanger; a switching valve located in the circulation path; and a controller configured to control the switching valve. The switching valve is configured to be selectively switched between a first valve position and a second valve position. When the switching valve is in the first valve position, the heat medium circulates between the heater and the power supply cooler, and a flow of the heat medium is cut off between the heater and the outside air heat exchanger. When the switching valve is in the second valve position, the heat medium circulates between the heater and the outside air heat exchanger, and the flow of the heat medium is cut off between the heater and the power supply cooler.

The controller is configured to, in a heating mode in which the heater is operated, control the switching valve to select the first valve position when a power supply temperature that is a temperature of the power supply is higher than a predetermined power supply temperature threshold, and control the switching valve to select the second valve position when the power supply temperature is equal to or lower than the power supply temperature threshold. The controller is configured to switch the switching valve from the first valve position to the second valve position regardless of the power supply temperature, when a temperature of the heat medium that has passed through the power supply cooler is lower than an outside air temperature by a predetermined margin temperature difference or more while the switching valve is in the first valve position.

When the power supply temperature is higher than the power supply temperature threshold, the first valve position is selected (i.e., the switching valve is in the first valve position) and the heat medium circulates between the heater and the power supply cooler. The heat medium absorbs heat from the high-temperature power supply and heats air in the vehicle cabin through the heater. When the temperature of the power supply is high, heat of the power supply is used for heating.

On the other hand, when the temperature of the power supply is equal to or lower than the power supply temperature threshold, the second valve position is selected (i.e., the switching valve is in the second valve position) and the heat medium circulates between the heater and the outside air heat exchanger. The heat medium absorbs heat from the outside air and heats the air in the vehicle cabin through the heater. When the temperature of the power supply is low, heat of the outside air is used for heating. A heat pump mechanism may be used to transfer the heat of the power supply or the outside air to the vehicle cabin. The heat pump mechanism will be described in an embodiment.

The controller switches the switching valve from the first valve position to the second valve position regardless of the power supply temperature, when the temperature of the heat medium that has passed through the power supply cooler is lower than the outside air temperature by the predetermined margin temperature difference or more while the switching valve is in the first valve position. For example, heat may not be transferred well from the power supply to the heat medium when a heat transfer sheet sandwiched between the power supply and the power supply cooler deteriorates or when a gap appears between the power supply and the power supply cooler due to vibration of the vehicle. Even when the power supply temperature is not low, the controller switches to heating using the heat of the outside air when heat is not transferred well from the power supply to the heat medium. By controlling the switching valve in this manner, the heat of the power supply and the heat of the outside air can be efficiently used to heat the vehicle cabin.

The controller may be configured to hold the switching valve in the second valve position for at least a predetermined holding time regardless of the power supply temperature, when the temperature of the heat medium that has passed through the power supply cooler is lower than the outside air temperature by the margin temperature difference or more. Hunting of the switching valve can thus be prevented.

Details and further improvements of the technique disclosed herein will be described in the “DETAILED DESCRIPTION OF EMBODIMENTS” section below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a thermal circuit diagram of a thermal management system of an embodiment (first valve position);

FIG. 2 is a thermal circuit diagram of the thermal management system of the embodiment (second valve position);

FIG. 3 is a flowchart of a process that is performed by a controller during heating; and

FIG. 4 is a thermal circuit diagram of an air conditioner.

### DETAILED DESCRIPTION OF EMBODIMENTS

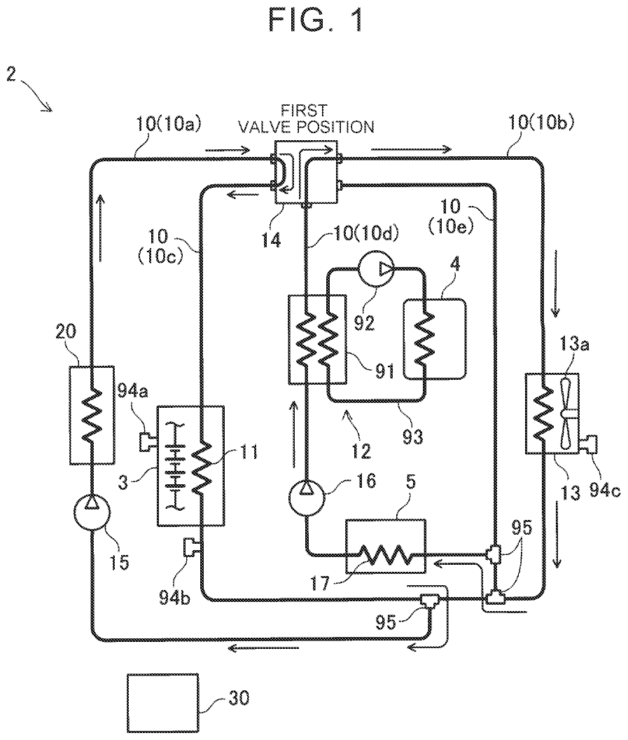

A thermal management system 2 of an embodiment will be described with reference to the drawings. FIG. 1 is a thermal circuit diagram of the thermal management system 2. In the embodiment, the “thermal circuit” means a circuit of a flow path through which a heat medium flows.

The thermal management system 2 is mounted on a battery electric vehicle. The thermal management system 2 adjusts the temperature of a vehicle cabin and keeps the temperatures of a power supply 3, a motor for traveling 4, and a power converter 5 within their appropriate temperature ranges. The electric power of the power supply 3 is converted to alternating current (AC) power suitable for driving the motor 4 by the power converter 5, and is supplied to the motor 4. The power supply 3 is typically a battery such as a lithium-ion battery, or a fuel cell, but may be other kinds of power supply. Power lines are not shown in FIG. 1.

The thermal management system 2 includes a circulation path 10 through which a heat medium flows; a power supply cooler 11 configured to cool the power supply 3; a motor cooler 12 configured to cool the motor 4; an outside air heat exchanger 13 configured to exchange heat between the heat medium and the outside air; an air conditioner 20 configured to adjust the temperature of the vehicle cabin; pumps 15, 16 configured to discharge the heat medium; and a switching valve 14 configured to switch the flow path for the heat medium.

The circulation path 10 is a pipe connecting the power supply cooler 11, the motor cooler 12, the outside air heat exchanger 13, the air conditioner 20, and the switching valve 14, and circulates the heat medium between the coolers and the air conditioner. For convenience of description, the circulation path 10 is divided into the following flow paths: an air conditioner flow path 10a passing through the air conditioner 20, a heat exchanger flow path 10b passing through the outside air heat exchanger 13, a power supply cooler flow path 10c passing through the power supply cooler 11, a motor cooler flow path 10d passing through the motor cooler 12, and a bypass flow path 10e. The motor cooler flow path 10d also passes through a converter cooler 17 configured to cool the power converter 5.

The air conditioner 20 adjusts the temperature of the vehicle cabin. The air conditioner 20 operates in two modes including a cooling mode in which the air conditioner 20 cools the vehicle cabin, and a heating mode in which the air conditioner 20 heats the vehicle cabin. The air conditioner 20 is shown in a simplified manner in FIG. 1. The structure of the air conditioner 20 will be described in detail later.

The power supply cooler 11 cools the power supply 3. The heat medium passing through the power supply cooler 11 absorbs the heat of the power supply 3 to cool the power supply 3.

The outside air heat exchanger 13 includes a fan 13a. The outside air introduced into the outside air heat exchanger 13 by the fan 13a exchanges heat with the heat medium passing through the outside air heat exchanger 13. The outside air heat exchanger 13 is generally called a radiator, but in the present embodiment, it is called an outside air heat exchanger because it may transfer heat from the outside air to the heat medium.

The motor cooler 12 includes an oil cooler 91, an oil pump 92, and an oil flow path 93. The motor cooler flow path 10d passes through the oil cooler 91. The oil flow path 93 passes through the oil cooler 91 and the motor 4. Oil flows through the oil flow path 93. The oil pump 92 is located in the oil flow path 93, and circulates oil between the oil cooler 91 and the motor 4. The motor 4 is cooled by the heat medium flowing through the circulation path 10. More specifically, the heat medium cools oil in the oil cooler 91, and the cooled oil cools the motor 4. The heat of the motor 4 is absorbed by the heat medium via the oil.

The thermal management system 2 includes temperature sensors 94a, 94b, and 94c. The temperature sensor 94a measures the temperature of the power supply 3. The temperature sensor 94b is located in the power supply cooler flow path 10c and measures the temperature of the heat medium that has passed through the power supply cooler 11. The temperature sensor 94c is mounted on the outside air heat exchanger 13 and measures the temperature of the outside air introduced into the outside air heat exchanger 13. The thermal management system 2 includes more temperature sensors, but description thereof is omitted.

The measured values of the temperature sensors 94a to 94c are sent to a controller 30. The controller 30 controls the pumps 15, 16, the oil pump 92, and the switching valve 14 based on the measured values of the temperature sensors 94a to 94c. The controller 30 is, for example, an electronic control unit including a processor.

First ends of the air conditioner flow path 10a, the heat exchanger flow path 10b, the power supply cooler flow path 10c, the motor cooler flow path 10d, and the bypass flow path 10e are connected to the switching valve 14. The switching valve 14 switches the connection among the air conditioner flow path 10a, the heat exchanger flow path 10b, the power supply cooler flow path 10c, the motor cooler flow path 10d, and the bypass flow path 10e. The connection among the flow paths by the switching valve 14 will be described in detail later. Second ends of the air conditioner flow path 10a, the heat exchanger flow path 10b, the power supply cooler flow path 10c, the motor cooler flow path 10d, and the bypass flow path 10e are connected by several three-way valves 95. The pumps 15, 16 are located in the circulation path 10. The pump 15 is located upstream of the air conditioner 20 in the air conditioner flow path 10a, and the pump 16 is located upstream of the motor cooler 12 in the motor cooler flow path 10d. The arrows shown along the flow paths indicate the directions of the flow of the heat medium. The pumps 15, 16 force the heat medium to flow toward the switching valve 14. The flow path for the heat medium is determined according to the state of the switching valve 14. The directions of the flow of the heat medium in the three-way valves 95 are dependently determined according to the flow path for the heat medium.

The switching valve 14 can be selectively switched between a first valve position and a second valve position (i.e., the position of the switching valve 14 can be selected between the first valve position and the second valve position). FIG. 1 shows the flow of the heat medium when the switching valve 14 is in the first valve position. When the switching valve 14 is in the first valve position, it connects the air conditioner flow path 10a to the power supply cooler flow path 10c and connects the heat exchanger flow path 10b to the motor cooler flow path 10d. At this time, the heat medium circulates between the air conditioner 20 and the power supply cooler 11, and also circulates between the motor cooler 12 and the outside air heat exchanger 13. When the switching valve 14 is in the first valve position, the heat medium circulating between the air conditioner 20 and the power supply cooler 11 and the heat medium circulating between the motor cooler 12 and the outside air heat exchanger 13 do not mix with each other. In other words, when the switching valve 14 is in the first valve position, the heat medium circulates between the air conditioner 20 and the power supply cooler 11, and the flow of the heat medium is cut off between the air conditioner 20 and the outside air heat exchanger 13.

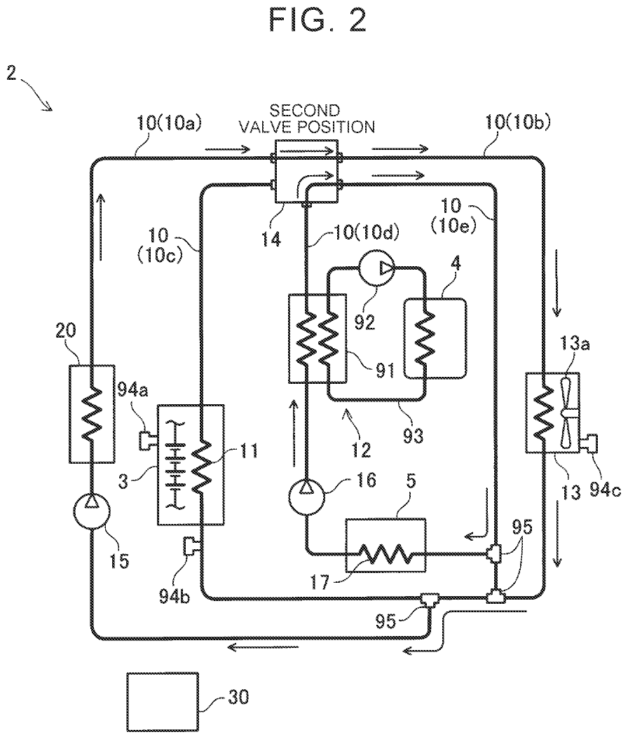

FIG. 2 shows the flow of the heat medium when the switching valve 14 is in the second valve position. When the switching valve 14 is in the second valve position, it connects the air conditioner flow path 10a to the heat exchanger flow path 10b and connects the motor cooler flow path 10d to the bypass flow path 10e. At this time, the heat medium circulates between the air conditioner 20 and the outside air heat exchanger 13, and also circulates between the motor cooler 12 and the bypass flow path 10e. When the switching valve 14 is in the second valve position, the heat medium circulating between the air conditioner 20 and the outside air heat exchanger 13 and the heat medium in the power supply cooler 11 do not mix with each other. In other words, when the switching valve 14 is in the second valve position, the heat medium circulates between the air conditioner 20 and the outside air heat exchanger 13, and the flow of the heat medium is cut off between the air conditioner 20 and the power supply cooler 11.

As described earlier, when the heating mode is selected, the air conditioner 20 heats the vehicle cabin. The heat of the power supply 3 or the heat of the outside air is used to heat the vehicle cabin.

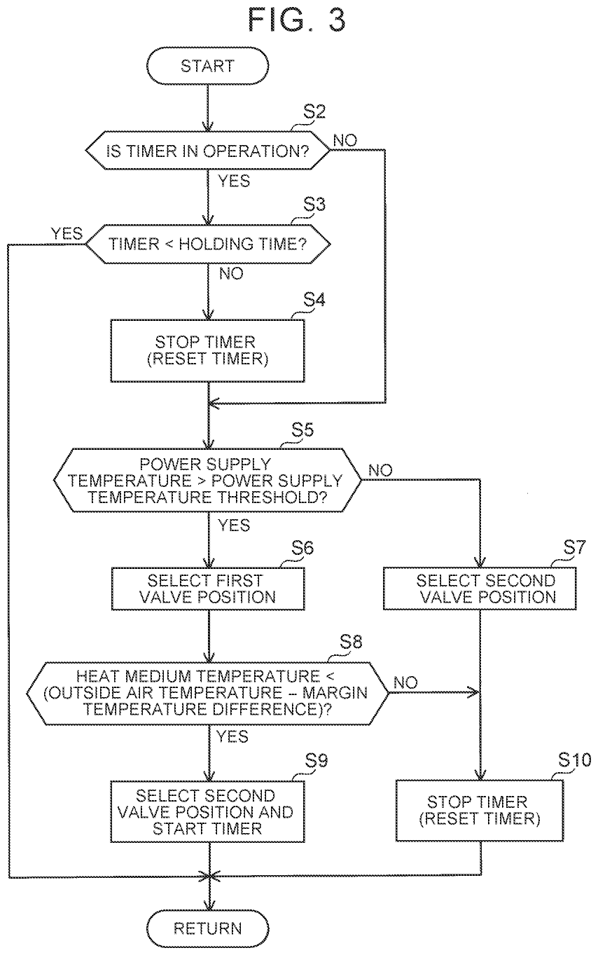

FIG. 3 is a flowchart of a process that is performed by the controller 30 during heating. When a timer is in operation in step S2, the controller 30 compares the elapsed time indicated by the timer with a predetermined holding time (step S2: YES, S3). The timer is a variable defined in a program that is executed by the controller 30, and measures the elapsed time since the start of the timer. The timer is started in step S9 that will be described later. Since the timer is normally stopped, the determination result of step S2 is “NO,” and the routine for the controller 30 proceeds to step S5. A condition for starting the timer will be described later.

The controller 30 compares the power supply temperature with a power supply temperature threshold (step S5). The power supply temperature is acquired by the temperature sensor 94a mounted on the power supply 3. The controller 30 controls the switching valve 14 to select the first valve position when the power supply temperature is higher than the power supply temperature threshold (step S5: YES, S6). The controller 30 controls the switching valve 14 to select the second valve position when the power supply temperature is equal to or lower than the power supply temperature threshold (step S5: NO, S7).

As shown in FIG. 1, when the first valve position is selected (i.e., when the switching valve 14 is in the first valve position), the heat medium circulates between the air conditioner 20 and the power supply cooler 11. At this time, movement of the heat medium is blocked between the air conditioner 20 and the outside air heat exchanger 13. The heat medium that has absorbed the heat of the power supply 3 in the power supply cooler 11 gives the heat to the air conditioner 20 while passing through the air conditioner 20. The air conditioner 20 uses the heat of the power supply 3 to heat the vehicle cabin.

As shown in FIG. 2, when the second valve position is selected (i.e., when the switching valve 14 is in the second valve position), the heat medium circulates between the air conditioner 20 and the outside air heat exchanger 13. At this time, movement of the heat medium is blocked between the air conditioner 20 and the power supply cooler 11. The heat medium that has absorbed heat from the outside air in the outside air heat exchanger 13 gives the heat to the air conditioner 20 while passing through the air conditioner 20. The air conditioner 20 uses the heat of the outside air to heat the vehicle cabin. The air conditioner 20 uses a heat pump mechanism to transfer heat from the power supply 3 or the outside air to the vehicle cabin. The structure of the air conditioner 20 will be described later.

As described above, the thermal management system 2 heats the vehicle cabin with the heat of the power supply 3 when the temperature of the power supply 3 is high, and heats the vehicle cabin with the heat of the outside air when the temperature of the power supply 3 is low.

As described below, however, even when the power supply temperature is high, the thermal management system 2 switches to heating with the heat of the outside air when heat is not transferred well from the power supply 3 to the heat medium. For example, heat may not be transferred well from the power supply to the heat medium when a heat transfer sheet sandwiched between the power supply and the power supply cooler deteriorates or when a gap appears between the power supply and the power supply cooler due to vibration of the vehicle.

After selecting the first valve position in step S6, the controller 30 compares the temperature of the heat medium that has passed through the power supply cooler 11 with the outside air temperature (step S8). The temperature of the heat medium that has passed through the power supply cooler 11 is acquired by the temperature sensor 94b located downstream of the power supply cooler 11, and the outside air temperature is acquired by the temperature sensor 94c mounted on the outside air heat exchanger 13.

When the temperature of the heat medium that has passed through the power supply cooler 11 is lower than the outside air temperature by a predetermined margin temperature difference or more (step S8: YES), the controller 30 switches the switching valve 14 from the first valve position to the second valve position regardless of the power supply temperature (step S9). The controller 30 holds the switching valve 14 in the first valve position when the temperature of the heat medium that has passed through the power supply cooler 11 is not lower than the outside air temperature by the predetermined margin temperature difference or more (step S8: NO).

As described above, when the switching valve 14 is set to the second valve position, the heat of the outside air is used to heat the vehicle cabin. The margin temperature difference is set to, for example, 5 degrees. When the temperature of the heat medium that has passed through the power supply cooler 11 is lower than the outside air temperature by 5 degrees or more, the controller 30 switches from heating with the heat of the power supply (first valve position) to heating with the heat of the outside air (second valve position). That is, when the temperature of the heat medium that is supplied to the air conditioner 20 becomes lower than the outside air temperature by the margin temperature difference or more while the switching valve 14 is in the first valve position, the controller 30 switches the switching valve 14 to the second valve position to switch to heating with the heat of the outside air.

When the determination result is YES in step S8, the controller 30 starts the timer and ends the process of FIG. 3 (step S9). When the determination result is NO in step S8, the controller 30 stops the timer and ends the process (step S10). The controller 30 resets the value of the timer to zero at the same time as the time when the controller 30 stops the timer.

The controller 30 repeats the process of FIG. 3 at regular intervals. After the timer is started in step S9, the switching valve 14 is held in the second valve position until the predetermined holding time elapses, regardless of the power supply temperature (step S2: YES, step S3: YES, return). On the other hand, when the predetermined holding time has elapsed since the start of the timer in step S9, the timer is stopped and step S5 and the subsequent steps are performed (steps S2: YES, S3: NO, S4). As in step S10, the controller 30 resets the value of the timer to zero at the same time as the time when the controller 30 stops the timer in step S4.

After the switching valve 14 is switched from the first valve position to the second valve position in step S9, the switching valve 14 is held in the second valve position for a certain holding time. By this process, the valve position is fixed even when the power supply temperature, the heat medium temperature, or the outside air temperature changes slightly. Hunting is thus prevented when the position of the switching valve 14 is switched. The holding time is set to, for example, 5 minutes.

In the thermal management system 2 of the present embodiment, even when the power supply temperature is high, the thermal management system 2 switches from heating with the heat of the power supply 3 to heating with the heat of the outside air when heat is not transferred well from the power supply 3 to the heat medium (that is, when the temperature of the heat medium that has passed through the power supply cooler 11 is low). By controlling the switching valve 14 in this manner, the heat of the power supply 3 and the heat of the outside air can be efficiently used to heat the vehicle cabin.

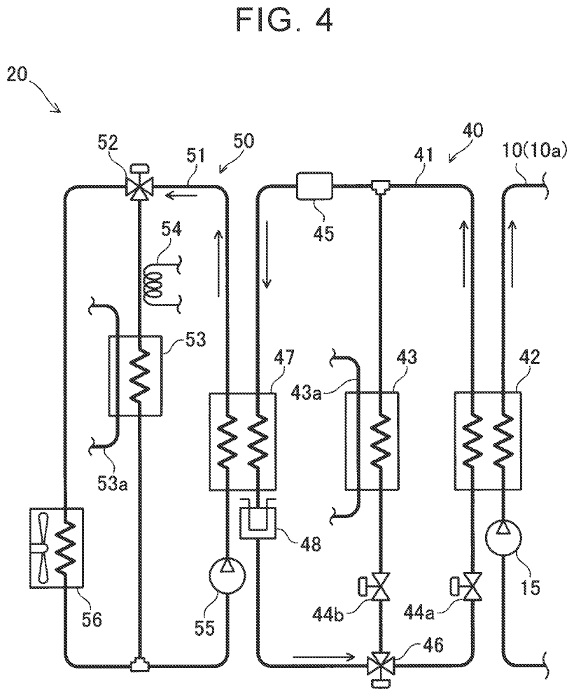

The structure of the air conditioner 20 will be described with reference to FIG. 4. The air conditioner 20 includes a first thermal circuit 40 and a second thermal circuit 50. The first thermal circuit 40 cools the vehicle cabin, and the second thermal circuit 50 heats the vehicle cabin. The first thermal circuit 40 also serves to transfer the heat of the heat medium flowing through the circulation path 10 to the second thermal circuit 50 during heating. For convenience of description, a thermal circuit that circulates the heat medium between the outside air heat exchanger 13 (or the power supply cooler 11) and the air conditioner 20 (that is, the circulation path 10 and the devices connected to the circulation path 10) is hereinafter referred to as the main thermal circuit.

The first thermal circuit 40 includes a circulation path 41, a chiller 42, an evaporator 43, expansion valves 44a, 44b, a compressor 45, a heat exchanger 47, a switching valve 46, and a modulator 48. The circulation path 41 connects the chiller 42, the evaporator 43, and the heat exchanger 47. A first heat medium flows through the circulation path 41. The switching valve 46 switches the flow path for the first heat medium. In the heating mode, the controller 30 controls the switching valve 46 so that the first heat medium circulates between the chiller 42 and the heat exchanger 47 and that the first heat medium does not flow to the evaporator 43.

The first heat medium that is a liquid changes to a gas and decreases in temperature as it passes through the expansion valve 44a. The first heat medium with the decreased temperature absorbs heat from the heat medium of the main thermal circuit and increases in temperature as it passes through the chiller 42. The first heat medium (gas) that has passed through the chiller 42 is compressed and liquified and further increases in temperature as it passes through the compressor 45. This high-temperature first heat medium is supplied to the heat exchanger 47. The first heat medium that has passed through the heat exchanger 47 is sent to the switching valve 46 via the modulator 48.

The second thermal circuit 50 includes a circulation path 51, a vehicle cabin heater 53, a radiator 56, and a switching valve 52. The circulation path 51 connects the heat exchanger 47, the vehicle cabin heater 53, and the radiator 56. A second heat medium flows through the circulation path 51. The switching valve 52 switches the flow path for the second heat medium. In the heating mode, the controller 30 controls the switching valve 52 so that the second heat medium circulates between the heat exchanger 47 and the vehicle cabin heater 53 and that the second heat medium does not flow to the radiator 56.

As described above, the high-temperature first heat medium flows to the heat exchanger 47. In the heating mode, the second heat medium absorbs heat from the first heat medium as it passes through the heat exchanger 47. The second heat medium with an increased temperature due to the heat of the first heat medium passes through the vehicle cabin heater 53. An air duct 53a through which air in the vehicle cabin flows also passes through the vehicle cabin heater 53. The vehicle cabin heater 53 heats the air in the vehicle cabin by the high-temperature second heat medium. When the second heat medium has low thermal energy, the controller 30 heats the second heat medium using an electric heater 54. In the heating mode, the heat of the power supply 3 or the heat of the outside air heats the vehicle cabin from the heat medium of the main thermal circuit via the first heat medium and the second heat medium. In the first thermal circuit 40, the first heat medium that has been vaporized and has decreased in temperature receives heat from the heat medium in the main thermal circuit, and the first heat medium that has been compressed and liquified and has further increased in temperature transfers heat to the second heat medium. By this cycle, heat can be transferred between the power supply 3 (or the outside air) and the vehicle cabin that have a small temperature difference therebetween. This cycle of the heat transfer between two thermal circuits with a small temperature difference therebetween is called a heat pump.

In the cooling mode, the controller 30 controls the switching valve 46 so that the first heat medium circulates between the evaporator 43 and the heat exchanger 47 and that the first heat medium does not flow to the chiller 42. An air duct 43a through which air in the vehicle cabin flows also passes through the evaporator 43. The first heat medium that is a liquid changes to a gas and decreases in temperature as it passes through the expansion valve 44a. The first heat medium with the decreased temperature cools the air in the vehicle cabin as it passes through the evaporator 43. The first heat medium (gas) that has passed through the evaporator 43 is compressed and liquified and increases in temperature as it passes through the compressor 45. The high-temperature first heat medium is supplied to the heat exchanger 47 and transfers heat to the second heat medium in the second thermal circuit 50. In the cooling mode, the controller 30 controls the switching valve 52 so that the second heat medium circulates between the heat exchanger 47 and the radiator 56 in the second thermal circuit 50 and that the second heat medium does not flow to the vehicle cabin heater 53. The heat of the second heat medium is dissipated to the outside air by the radiator 56. The first heat medium cooled by the heat exchanger 47 is sent to the switching valve 46 via the modulator 48, and is vaporized and decreases in temperature as it passes through the expansion valve 44b.

As described above, the thermal management system 2 can efficiently use the heat of the power supply and the heat of the outside air to heat the vehicle cabin.

Points to be noted regarding the technique described in the embodiment will be described. The air conditioner 20 in the heating mode is an example of the heater that heats the vehicle cabin.

While specific examples of the disclosure are described in detail above, these examples are merely illustrative, and are not intended to limit the scope of the disclosure. The technique defined in the disclosure includes various modifications and alterations of the specific examples illustrated above. The technical elements illustrated in the present specification or the drawings have technical utility alone or in various combinations, and are not limited to the combinations described in the disclosure as originally filed. The technique illustrated in the present specification or the drawings may achieve a plurality of objects at the same time, and has technical utility by achieving one of the objects.

What is claimed is:

1. A thermal management system for a battery electric vehicle, the thermal management system comprising:
a power supply that supplies electric power to a motor for traveling;
a power supply cooler that cools the power supply with a heat medium;
a heater that heats a vehicle cabin with heat of the heat medium;
an outside air heat exchanger that exchanges heat between the heat medium and outside air;
a circulation path that connects the power supply cooler, the heater, and the outside air heat exchanger, and through which the heat medium flows;
a switching valve located in the circulation path, the switching valve being configured to be selectively switched between a first valve position and a second valve position, and the switching valve being configured such that when the switching valve is in the first valve position, the heat medium circulates between the heater and the power supply cooler and a flow of the heat medium is cut off between the heater and the outside air heat exchanger, and when the switching valve is in the second valve position, the heat medium circulates between the heater and the outside air heat exchanger and the flow of the heat medium is cut off between the heater and the power supply cooler;
a controller configured to control the switching valve, wherein the controller is configured to, in a heating mode in which the heater is operated,
control the switching valve to select the first valve position when a power supply temperature that is a temperature of the power supply is higher than a predetermined power supply temperature threshold, and control the switching valve to select the second valve position when the power supply temperature is equal to or lower than the predetermined power supply temperature threshold, and
switch the switching valve from the first valve position to the second valve position regardless of the power supply temperature, when a temperature of the heat medium that has passed through the power supply cooler is lower than an outside air temperature by a predetermined margin temperature difference or more while the switching valve is in the first valve position.

2. The thermal management system according to claim 1, wherein the controller is configured to hold the switching valve in the second valve position for at least a predetermined holding time regardless of the power supply temperature, when the temperature of the heat medium that has passed through the power supply cooler is lower than the outside air temperature by the predetermined margin temperature difference or more.

3. The thermal management system according to claim 1, wherein the predetermined margin temperature difference is 5 degrees.

4. The thermal management system according to claim 2, wherein the predetermined holding time is 5 minutes.
